(19) United States
(12) Patent Application Publication
(10) Pub. No.: US 2026/0185184 A1
(43) Pub. Date: Jul. 2, 2026

(54) SYSTEM AND METHOD FOR SEPARATION OF ACTIVE MATERIAL FROM LITHIUM-ION BATTERIES

(71) Applicant: METASTABLE MATERIALS PRIVATE LIMITED, Baghpat, Uttar Pradesh (IN)

(72) Inventor: Shubham VISHVAKARMA, Baraut (IN)

(73) Assignee: METASTABLE MATERIALS PRIVATE LIMITED, Baghpat, Uttar Pradesh (IN)

(21) Appl. No.: 18/746,022

(22) PCT Filed: Jan. 30, 2023
(86) PCT No.: PCT/IN2023/050087

§ 371 Date: Jun. 17, 2024

(30) Foreign Application Priority Data
Feb. 3, 2022 (IN) 202211005730

(51) Int. Cl. C22B 7/00; C22B 26/12

(52) U.S. Cl. CPC C22B 7/005; C22B 7/006; C22B 26/12

(57) ABSTRACT

The various embodiments of the present invention provide a system and method for separation of active material from Lithium-ion batteries. The system comprises a fluid chamber, a shredder-crusher apparatus, a material inlet mechanism, a gas outlet mechanism and a material outlet mechanism. After a plurality of processes, the high-density material such as Aluminium, Copper, Iron etc. are separated by size classification. The liquid suspension is allowed to settle, and the water on the top and powder settled on the bottom are collected. The powder separated from suspension is deemed as black mass, and it comprises the active material from the Lithium-ion battery. The agitation tank breaks material introduced in it into smaller sizes in proportion to the brittleness. The material is then processed through a density separation, followed by wet-side classification to separate metals and active material, followed by dewatering.

### REFERENCE TO RELATED APPLICATION

The embodiments herein claim the priority of the Indian Provisional Patent Application filed on Feb. 3, 2022, with the number 202211005730 and PCT Applic. No. PCT/IN2023/050087, filed Jan. 30, 2023, the contents of which are incorporated herein by reference.

### FIELD OF THE INVENTION

The present invention is generally related to Lithium-ion batteries. The present invention is particularly related to system and method for enabling a safe disposal of Lithium-ion batteries. The present invention is more particularly related to a system and method for separation of metal and active material from Lithium-ion batteries.

### BACKGROUND OF THE INVENTION

The safe disposal of used Lithium-ion batteries has attained significant importance in the recent past owing to their large-scale production for powering a variety of devices and appliances. Currently the safe disposal of used Lithium-ion batteries are not without their challenges, mainly owing to the presence of active material, stored energy and other hazardous constituents in the used batteries.

In current methods, for separating active material from Lithium-ion batteries, a process of crushing is performed, followed by air classification and sieving. This process is done either in a neutral or inert atmosphere of Nitrogen or Argon, or under cryogenic conditions to avoid fire. Some current methods also involve spraying water with additive during the crushing process, and while this process mitigates some of the issues faced, it does not fully solve them. Also, the process used typically do not directly produce material of high purity.

Hence, there exists a need for an efficient and safe system for separating active material from Lithium-ion batteries.

The abovementioned shortcomings, disadvantages and problems are addressed herein, which will be understood by reading and studying the following specification.

### OBJECT OF THE INVENTION

The primary object of the present invention is to provide a system and method for safe separation of active material from Lithium-ion batteries.

Another object of the present invention is to provide an efficient and safe system for separating active material from Lithium-ion batteries.

Yet another object of the present invention is to provide a contained shredding system that shred the batteries in submersed warm water or other fluid to open the enclosed system and reduce the size of components.

Yet another object of the present invention is to provide agitation process in water and subsequent use of impact of agitation and vigorous nature separation process, and particle-particle grinding to separate the components of battery and classification using wet sieving.

Yet another object of the present invention is to provide a system that is configured to use a thermal shock to separate the black mass that has been pasted using PVDF on the foils.

These and other objects and advantages of the present invention will become readily apparent from the following detailed description taken in conjunction with the accompanying drawings.

### SUMMARY OF THE INVENTION

The various embodiments of the present invention provide a system and method for separation of active material from Lithium-ion batteries. The system comprises a fluid chamber, a shredder-crusher apparatus, a material inlet mechanism, a gas outlet mechanism and a material outlet mechanism.

According to one embodiment of the present invention, a system is provided for an efficient and safe separation of active material from Lithium-ion batteries. The batteries are first washed with water to remove the dirt content, and then shredded in a shredder. The shredder is constantly fed with the scrape batteries. The shredder is submerged in demineralized cold water or other fluid inside a sealed tank so that shredding operation always happens under water or fluid, and exhaust gases are trapped. The batteries are shredded with the blades breaking the complex structure into smaller pieces; any remaining energy stored in batteries create localized areas of heat that separates the active material from foil. Some electrolyte solvent used in batteries has a low boiling point and is boiled because of localized heating while the electrolyte reacts with water. The other electrolyte solvent used in batteries dissolves in fluid while the electrolyte reacts with water. The volatile organics, such as vapour and exhaust gases, getting exhausted are scrubbed, compressed and cooled to be stored in a container.

According to one embodiment of the present invention, the shredded or crushed material is subject to an agitation environment such as an agitation tank or agitator. The agitator is run for preselected processing conditions (such as runtime, solid/liquid ratio and RPM). After the agitation the tank is allowed to partially settle, due to which, three distinct components are formed and collected, namely the low-density material at top, the liquid suspension and settled high-density material at the bottom. The high-density material such as Aluminium, Copper, Iron etc are separated by size classification. The liquid suspension is allowed to settle, and the water on the top and powder settled on the bottom are collected. The powder separated from suspension is deemed as black mass, and the liquid is evaporated to collect electrolyte.

According to one embodiment of the present invention, the agitation tank is configured to break the plurality of material introduced in it into smaller sizes in proportion to the brittleness of the material. Since the agitation tank is submerged in the fluid environment, the ductile material remains as larger particles while a plurality of other material is powdered and form a suspension in the fluid. The suspension is removed first and processed through a screen and then the larger particles are separated through density separation. The suspension and the larger particles are then processed through a wet-size classification system to separate material of different size, followed by dewatering.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a system for separation of active material from Lithium-ion batteries, according to one embodiment of the present invention.

FIG. 2 illustrates an exemplary system for separation of active material from Lithium-ion batteries, according to one embodiment of the present invention.

FIG. 3 illustrates a method for separation of active material from Lithium-ion batteries, according to one embodiment of the present invention.

FIG. 4 illustrates an SEM image after shedding of Lithium-ion batteries, according to one exemplary embodiment of the present invention.

FIG. 5 illustrates an SEM image of different constituents after size and density separation of shredded Lithium-ion batteries, according to one exemplary embodiment of the present invention.

FIG. 6 illustrates the XRD results readings and charts of different constituents of shredded Lithium-ion batteries after size and density separation, according to one exemplary embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for separation of metals and active material from Lithium-ion batteries. The system comprises a fluid chamber, a shredder-crusher apparatus, a material inlet mechanism, a gas outlet mechanism and a material outlet mechanism.

According to one embodiment of the present invention, the fluid chamber further comprises a fluid such as water, and a washing mechanism that is designed to remove the dirt content introduced into the fluid chamber. The shredder-crusher apparatus is comprised and submerged in the fluid chamber such that all the operations of the shredder-crusher apparatus are enabled in a fluid environment so that the exhaust gases produced are trapped. The material inlet mechanism is designed to be further connected to an agitation tank, where the agitation tank is comprised in the fluid chamber and the agitation tank is designed to operate in a fluid environment and enable wet sieving. The gas outlet mechanism is designed to pass the exhaust gases produced through a scrubber, followed by a compressor and a cooler so that the gases are compressed, liquefied and cooled to be stored in a container. The material outlet mechanism is designed to remove the separated material.

According to one embodiment of the present invention, the temperature of the fluid in the fluid chamber is maintained to be below the boiling point of the electrolyte solution of the batteries through active cooling.

According to one embodiment of the present invention, the agitation tank is designed to be operated on preset conditions. The agitation tank is configured to break the plurality of material introduced in it into smaller sizes in proportion to the brittleness of the material. Since the agitation tank is submerged in the fluid environment, the ductile material remains as larger particles while a plurality of other material is powdered and form a suspension in the fluid. The suspension is removed first and processed through a screen and then the larger particles are separated through density separation. The suspension and the larger particles are then processed through a wet-size classification system to separate material of different size, followed by dewatering.

According to one embodiment of the present invention, the agitation tank is maintained at slightly acidic condition by introducing an additional fluid in the fluid environment. Once the process is completed, the fluid used in the process is processed to extract the dissolved material. When the purity of the size component of the material is not pure as per preset standards, the material is subjected to thermal shock in hot and cold water, and reprocessed in the agitation tank.

According to one embodiment of the present invention, a method is provided for separation of active material from Lithium-ion batteries. The method comprises: washing the Lithium-ion batteries in a fluid chamber to remove the dirt and discharge; shredding of batteries in a shredder-crusher apparatus that is submerged in a fluid environment in the fluid chamber; removing gaseous exhausts through a gas outlet mechanism; transferring the shredded material to an agitation tank, wherein the agitation tank is designed to operate in a fluid environment and enable wet sieving; separating the shredded material into fine and coarse by breaking the shredded material into smaller sizes in proportion to the brittleness of the material, and wherein, the coarse material are ductile material which remain as larger particles, and fine material are powdered and form a suspension in the fluid; subjecting the material to coarse-fine segregation and density separation; classifying, by size, the fine and coarse material through sieving; dewatering the separated material by removing water and moisture through appropriate setup; and, removing the separated material through a material outlet mechanism.

According to one embodiment of the present invention, a system is provided for an efficient and safe separation of active material from Lithium-ion batteries. The batteries are first washed with water to remove the dirt content, and then shredded in a shredder. The shredder is constantly fed with the scrap batteries. The shredder is submerged in distilled hot water or other fluid inside a sealed tank so that shredding operation always happens under water or fluid, and exhaust gases are be trapped. The batteries are shredded with the blades breaking the complex structure into smaller pieces; any remaining energy stored in batteries create localized areas of heat that separates the active material from foil. The electrolyte used in batteries has a low boiling point and is boiled while the electrolyte reacts with water. The electrolyte solvent used in batteries dissolves in fluid while the electrolyte reacts with water. The volatile organics, such as vapour and exhaust gases, that are getting exhausted are compressed and cooled to be stored in a container.

According to one embodiment of the present invention, the shredded or crushed material is subject to an agitation environment such as an agitation tank or agitator. The agitator is run for preselected processing conditions (such as runtime, solid/liquid ratio and RPM). After the agitation the tank is allowed to partially settle, due to which, three distinct components are formed and collected, namely the low-density material at top, the liquid suspension and settled high-density material at the bottom. The high-density material such as Aluminium, Copper, Iron etc are separated by size classification. The liquid suspension is allowed to settle, and the water on the top and powder settled on the bottom are collected. The powder separated from suspension is deemed as black mass, and the liquid is evaporated to collect electrolyte.

According to one embodiment of the present invention, the agitation tank is configured to break the plurality of material introduced in it into smaller sizes in proportion to the brittleness of the material. Since the agitation tank is submerged in the fluid environment, the ductile material remains as larger particles while a plurality of other material is powdered and form a suspension in the fluid. The suspension is removed first and processed through a screen and then the larger particles are separated through density separation. The suspension and the larger particles are then processed through a wet-size classification system to separate material of different size, followed by dewatering.

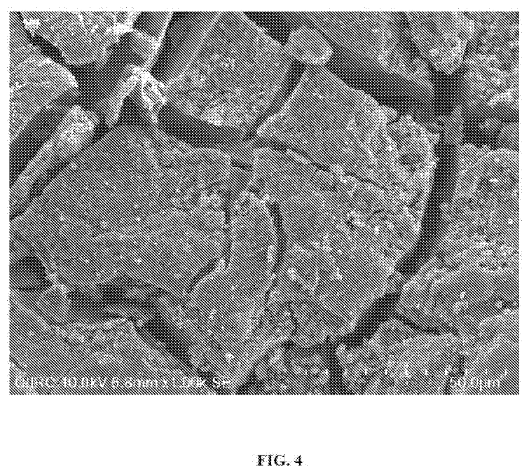

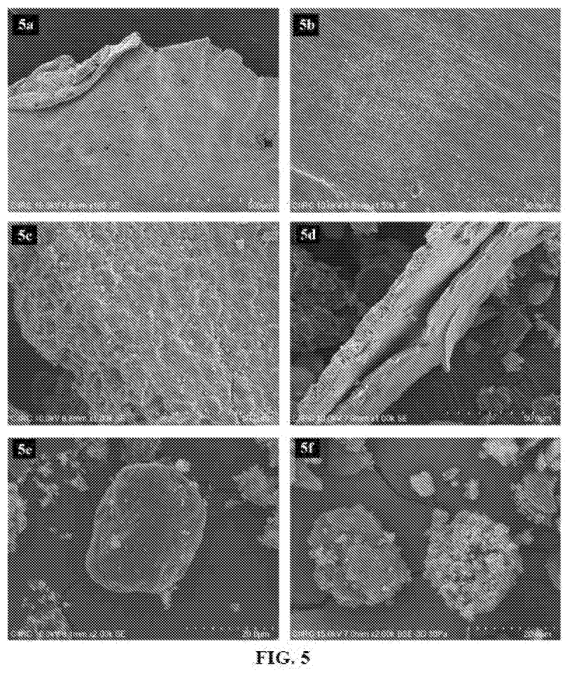

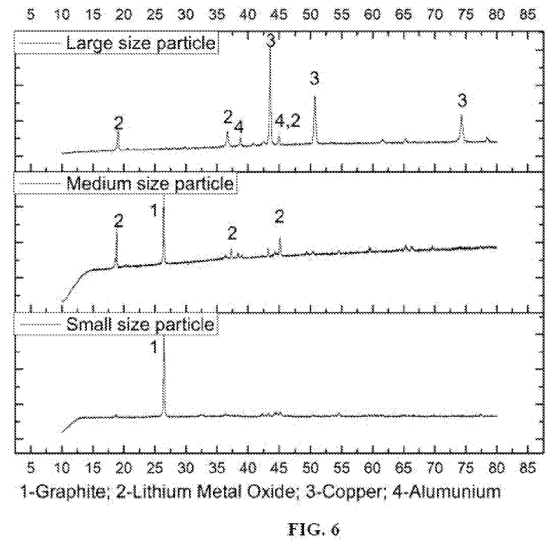

According to one embodiment, an exemplary system, method and results for an efficient and safe separation of active material from Lithium-ion batteries are provided. A 200-kg batch of batteries with charge were shredded in one hour in demineralized water to ˜7.5 mm particle size. FIG. 4 illustrates the SEM image after shedding, wherein the cracks in the SEM image indicate that the underwater shredding has enabled a safe shredding by creating localized areas of heat. After shredding, the material was agitated at 600 rpm and 1/5 Solid-to-Liquid ratio with a Carbon dioxide flow rate of 5 LPM for 45 minutes. Then subsequently, the material was subjected to size and density classification in demineralized water. The sieve sizes were uniformly distributed between 44 microns to 5 mm. FIG. 5 illustrates an SEM image of different constituents after size and density separation, and FIG. 6 illustrates the XRD results readings and charts. Both the figures illustrate a good separation of different constituent of material inside a Lithium-ion battery, and separation of metal and black-mass.

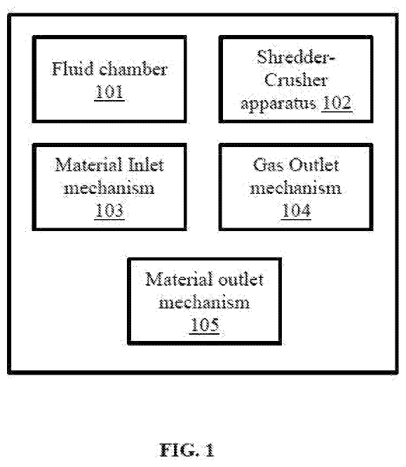

FIG. 1 illustrates a system for separation of active material from Lithium-ion batteries. The system comprises a fluid chamber 101, a shredder-crusher apparatus 102, a material inlet mechanism 103, a gas outlet mechanism 104 and a material outlet mechanism 105.

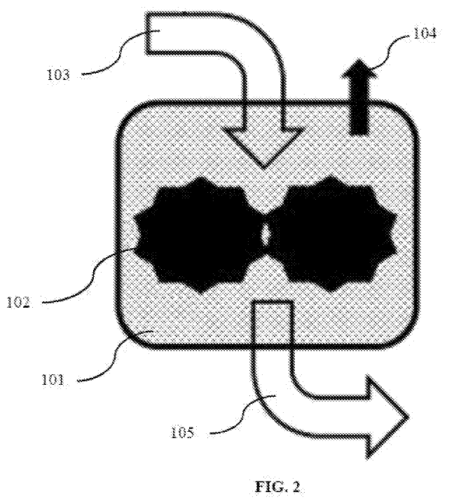

FIG. 2 illustrates an exemplary separation module provided in a system for separation of active material from Lithium-ion batteries.

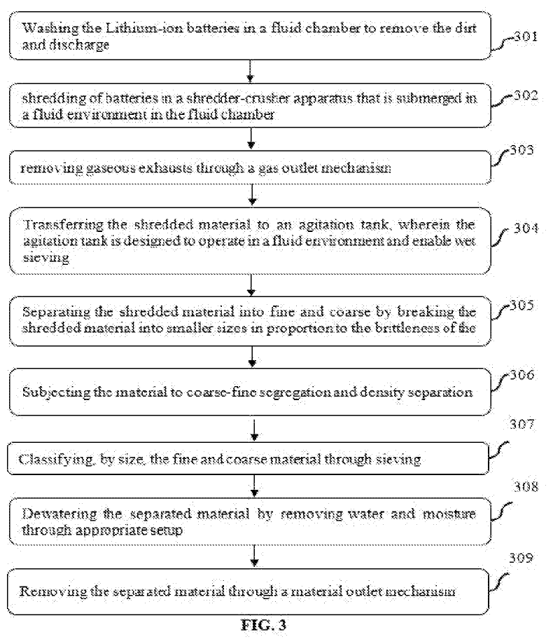

FIG. 3 illustrates a method for separation of active material from Lithium-ion batteries. The method comprises: washing the Lithium-ion batteries in a fluid chamber to remove the dirt (301); shredding of batteries in a shredder-crusher apparatus that is submerged in a fluid environment in the fluid chamber (302); removing gaseous exhausts through a gas outlet mechanism (303); transferring the shredded material to an agitation tank, wherein the agitation tank is designed to operate in a fluid environment and enable wet sieving (304); separating the shredded material into fine and coarse by breaking the shredded material into smaller sizes in proportion to the brittleness of the material, and wherein, the coarse material are ductile material which remain as larger particles, and fine material are powdered and form a suspension in the fluid (305); subjecting the material to coarse-fine segregation and density separation (306); classifying, by size, the fine and coarse material through sieving (307); dewatering the separated material by removing water and moisture through appropriate setup (308); and, removing the separated material through a material outlet mechanism (309).

FIG. 4 illustrates an SEM image after shedding of Lithium-ion batteries. The cracks in the SEM image indicate that the underwater shredding has enabled a safe shredding by creating localized areas of heat.

FIG. 5 illustrates an SEM image of different constituents after size and density separation of shredded Lithium-ion batteries. 5a and 5b illustrate large sized particles such as, Copper, Aluminum and Lithium metal oxide content. 5c and 5d illustrate medium sized particles such as Lithium metal oxide, Graphite and some metal content. 5e and 5f illustrate small sized particles such as, Graphite and some Lithium metal oxide content.

FIG. 6 illustrates the XRD results readings and charts of different constituents of shredded Lithium-ion batteries after size and density separation. The figure illustrates a good separation of different constituent of material inside a Lithium-ion battery, and separation of metal and black-mass.

Although the embodiments herein are described with various specific embodiments, it will be obvious for a person skilled in the art to practice the embodiments herein with modifications.

### Advantageous Effects of the Invention

The various embodiments of the present invention provide a system and method for separation of active material from Lithium-ion batteries. The present invention removes the necessity of discharging batteries and a requirement of additional preventive measures to avoid hazard of batteries. The present invention does not require a neutral or cryogenic environment, and improves the efficiency of the separation process by minimizing contamination, along with providing a classification of the separated component which are higher in purity and yield compared to currently used conventional methods.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for separation of active material from Lithium-ion batteries, the system comprising:
a fluid chamber, wherein the fluid chamber further comprises a fluid such as water, and a washing mechanism that is designed to remove the dirt content introduced into the fluid chamber;
a shredder-crusher apparatus, wherein the shredder-crusher apparatus is comprised and submerged in the fluid chamber such that all the operations of the shredder-crusher apparatus are enabled in a fluid environment so that the exhaust gases produced are trapped;
a material inlet mechanism, wherein, the material inlet mechanism is designed to be further connected to an agitation tank, wherein the agitation tank is comprised in the fluid chamber and the agitation tank is designed to operate in a fluid environment and enable wet sieving;
a gas outlet mechanism, wherein the gas outlet mechanism is designed to pass the exhaust gases produced through a scrubber, followed by a compressor and a cooler so that the gases are compressed, liquefied and cooled to be stored in a container; and,
a material outlet mechanism, wherein the material outlet mechanism is designed to remove the separated material.

2. The system as claimed in claim 1, wherein the temperature of the fluid in the fluid chamber is maintained to be below the boiling point of the electrolyte solution of the batteries through active cooling.

3. The system as claimed in claim 1, wherein the agitation tank is designed to be operated on preset conditions, and wherein the agitation tank is configured to break the plurality of material introduced in it into smaller sizes in proportion to the brittleness of the material, and wherein, since the agitation tank is submerged in the fluid environment, the ductile material remain as larger particles while a plurality of other material are powdered and form a suspension in the fluid, and wherein, the suspension is removed first and processed through a screen and then the larger particles are separated through density separation, and wherein, the suspension and the larger particles are then processed through a wet-size classification system to separate material of different size, followed by dewatering.

4. The system as claimed in claim 3, wherein the agitation tank is maintained at slightly acidic condition by introducing an additional fluid in the fluid environment, and wherein, once the process is completed, the fluid used in the process is processed to extract the dissolved material, and wherein, when the purity of the size component of the material is not pure as per preset standards, the material are subjected to thermal shock in hot and cold water, and reprocessed in the agitation tank.

5. A method for separation of active material from Lithium-ion batteries, the method comprising:
washing the Lithium-ion batteries in a fluid chamber to remove the dirt;
shredding of batteries in a shredder-crusher apparatus that is submerged in a fluid environment in the fluid chamber;
removing gaseous exhausts through a gas outlet mechanism;
transferring the shredded material to an agitation tank, wherein the agitation tank is designed to operate in a fluid environment and enable wet sieving;
separating the shredded material into fine and coarse by breaking the shredded material into smaller sizes in proportion to the brittleness of the material, and wherein, the coarse material are ductile material which remain as larger particles, and fine material are powdered and form a suspension in the fluid;
subjecting the material to coarse-fine segregation and density separation;
classifying, by size, the fine and coarse material through sieving;
dewatering the separated material by removing water and moisture through appropriate setup; and,
removing the separated material through a material outlet mechanism.

6. The method as claimed in claim 5, wherein the fluid chamber further comprises a fluid such as water or Propanol, and wherein the shredder-crusher apparatus is comprised and submerged in the fluid chamber such that all the operations of the shredder-crusher apparatus are enabled in a fluid environment so that the exhaust gases produced are trapped.

7. The method as claimed in claim 5, wherein the gas outlet mechanism is designed to pass the exhaust gases produced through a scrubber, followed by a compressor and a cooler so that the gases are compressed and cooled to be stored in a container.

8. The method as claimed in claim 5, wherein the temperature of the fluid in the fluid chamber is maintained to be below the boiling point of the electrolyte solution of the batteries through active cooling.

9. The method as claimed in claim 5, wherein the agitation tank is maintained at slightly acidic condition by introducing an additional fluid in the fluid environment, and wherein, once the process is completed, the fluid used in the process is processed to extract the dissolved material, and wherein, when the purity of the size component of the material is not pure as per preset standards, the material are subjected to thermal shock in hot and cold water, and reprocessed in the agitation tank.
